(19) United States
(12) Patent Application Publication
(10) Pub. No.: US 2013/0176508 A1
(43) Pub. Date: Jul. 11, 2013

(54) TELEVISION AND ELECTRONIC APPARATUS

(71) Applicant: Kabushiki Kaisha Toshiba, Tokyo (JP)

(72) Inventors: Shawcherng Chuo, Ome-shi (JP); Toshio Ooe, Akishima-shi (JP)

(73) Assignee: KABUSHIKI KAISHA TOSHIBA, Tokyo (JP)

(21) Appl. No.: 13/710,264

(22) Filed: Dec. 10, 2012

(30) Foreign Application Priority Data
Jan. 6, 2012 (JP) 2012-001543

(51) Int. Cl. H04N 5/64

(52) U.S. Cl. CPC H04N 5/64
USPC 348/836

(57) ABSTRACT

According to one embodiment, a television according to an embodiment is provided with a display panel including one surface and the other surface opposite the one surface and a cabinet which includes a first face along the one surface, a second face along the other surface, a third face longitudinally extending so as to be continuous with the first and second faces and projecting outward, and a fourth face facing the third face so as to be continuous with the first and second faces and including a first recess recessed inward and accommodates the display panel.

### CROSS-REFERENCE TO RELATED APPLICATIONS

This application is based upon and claims the benefit of priority from prior Japanese Patent Application No. 2012-001543, filed Jan. 6, 2012, the entire contents of which are incorporated herein by reference.

### FIELD

Embodiments described herein relate generally to a television and an electronic apparatus with an operating unit.

### BACKGROUND

The main body of some known display devices is furnished with an operating unit.

If the operating unit is attached to the main body, it may sometimes affect the external appearance of a product. On the other hand, the user-friendliness of the operating unit should be taken into consideration.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary front view showing a television as an example of an electronic apparatus according to a first embodiment;

FIG. 2 is an exemplary side view of the television taken from the right-hand side of FIG. 1;

FIG. 3 is an exemplary sectional view taken along line F3-F3 of FIG. 1;

FIG. 4 is an exemplary schematic top view illustrating how the television shown in FIG. 1 strikes a wall;

FIG. 5 is an exemplary side view of a television as an example of an electronic apparatus according to a second embodiment taken from the right-hand side;

FIG. 6 is an exemplary front view showing a portable computer as an example of an electronic apparatus according to a third embodiment;

FIG. 7 is an exemplary top view showing the top side of the portable computer shown in FIG. 6;

FIG. 8 is an exemplary bottom view showing the bottom side of the portable computer of FIG. 6;

FIG. 9 is an exemplary side view of the portable computer taken from the right-hand side of FIG. 6;

FIG. 10 is an exemplary rear view showing the interior of a first case of a cabinet of the portable computer of FIG. 6 with a second case removed;

FIG. 11 is an exemplary exploded perspective view showing the second case and a case body and intermediate member of the first case of the portable computer of FIG. 6;

FIG. 12 is an exemplary enlarged front view showing control buttons of the portable computer of FIG. 6 and their surroundings;

FIG. 13 is an exemplary sectional view of the portable computer taken along line F13-F13 of FIG. 6;

FIG. 14 is an exemplary sectional view of the portable computer taken along line F14-F14 of FIG. 6;

FIG. 15 is an exemplary enlarged partial top view of the portable computer shown in FIG. 7;

FIG. 16 is an exemplary enlarged perspective view showing a power button of the portable computer of FIG. 6 and its surroundings;

FIG. 17 is an exemplary enlarged sectional view showing a speaker and a sixth face (third recess) of the cabinet of the portable computer of FIG. 6;

FIG. 18 is an exemplary enlarged sectional view showing a label and the sixth face (third recess) of the cabinet of the portable computer of FIG. 6;

FIG. 19 is an exemplary sectional view illustrating how the second case of the cabinet of the portable computer of FIG. 6 is removed from or attached to the first case;

FIG. 20 is an exemplary side view of the portable computer taken from the left-hand side of FIG. 6; and

FIG. 21 is an exemplary rear view of a modification of the portable computer as an example of the electronic apparatus of the third embodiment, showing the interior of the first case with the second case removed.

### DETAILED DESCRIPTION

Various embodiments will be described hereinafter with reference to the accompanying drawings.

In general, according to one embodiment, a television according to an embodiment is provided with a display panel including one surface and the other surface opposite the one surface and a cabinet which includes a first face along the one surface, a second face along the other surface, a third face longitudinally extending so as to be continuous with the first and second faces and projecting outward, and a fourth face facing the third face so as to be continuous with the first and second faces and including a first recess recessed inward and accommodates the display panel.

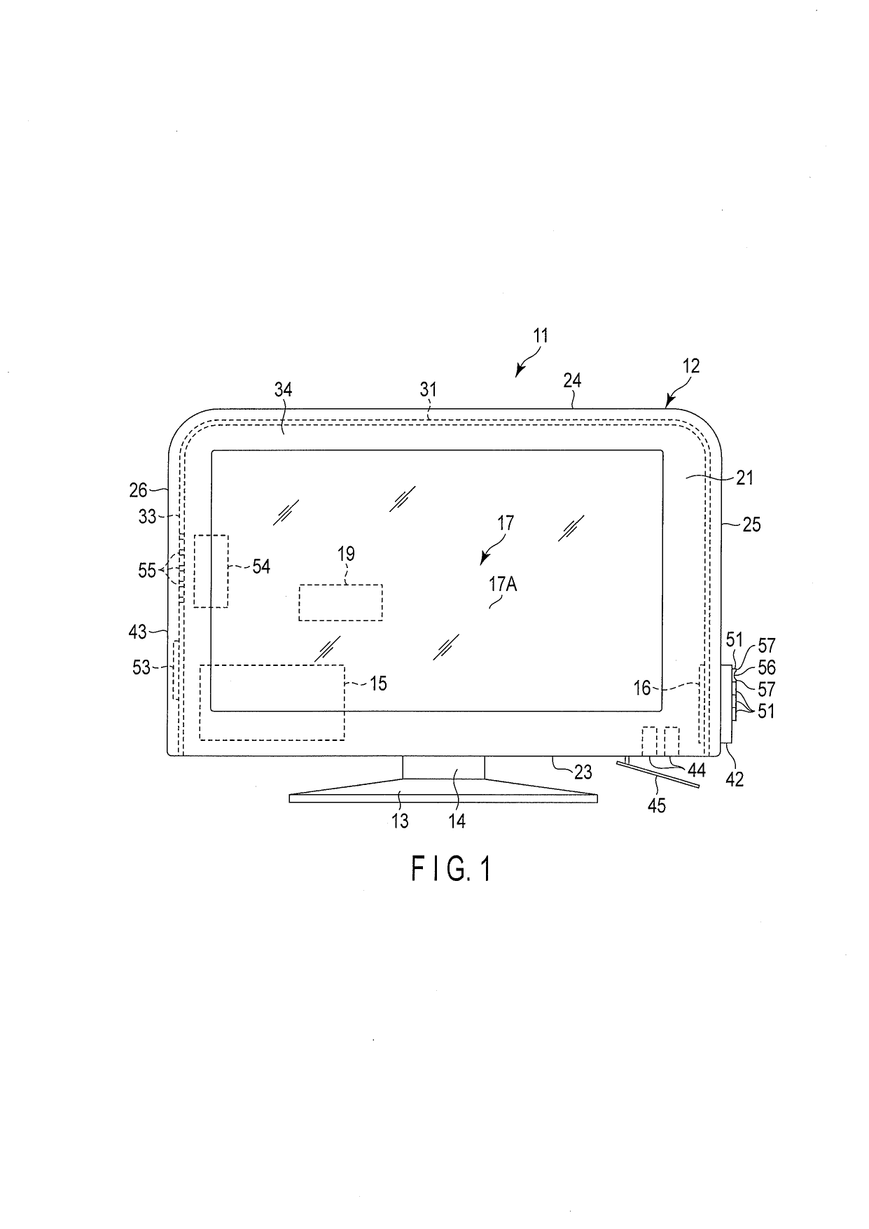

A first embodiment of an electronic apparatus will now be described with reference to FIGS. 1 to 4. As shown in FIG. 1, a television 11 as an example of the electronic apparatus according to the present embodiment comprises a display device (equipment such as an electronic apparatus, television, television receiver, receiver, broadcast-wave receiving apparatus, receiving apparatus, image display apparatus, apparatus, or display panel) having a substantially oblong (rectangular, flat box-like, or oblong as viewed from the front) external appearance. The television of the first embodiment has a configuration similar to that of a portable computer according to a third embodiment. Therefore, the television will be described here only in brief and its details will be described in connection with the third embodiment and with reference to the drawings in the third embodiment, if necessary.

As shown in FIG. 1, the television 11 comprises a cabinet (housing, case, shell, external member, protective member, or part) 12 and leg portion (stand, supporting portion, pedestal portion, support, projecting portion, or extending portion) 13 which supports the cabinet 12. The leg portion 13 comprises a swivel portion (revolving part, rotating part, pivoting part, displacement part, position control unit, or moving part) 14 for turning the cabinet 12 in a horizontal direction (direction along an external mounting surface).

The cabinet 12 of the television 11 accommodates therein a tuner substrate (printed circuit board, substrate, electronic component, component, tuner section, tuner device, or tuner control section) 19, system substrate (printed circuit board, substrate, electronic component, component, system section, or control section) 15, power circuit substrate (printed circuit board, substrate, electronic component, component, power supply section, power junction, or power control section), switch substrate (printed circuit board, substrate, electronic component, component, switch section, or system substrate control section) 16, and display panel 17. The system substrate 15 generally controls various parts of the television 11. The switch substrate 16 is electrically connected to the system substrate 15 by, for example, a flexible cable. The display panel 17 is in the form of a flat plate (having a sheet-like or flat face) comprising one surface (surface, face, part, or region) 17A on which an image as a display picture is displayed and the other surface (surface, face, part, region, part opposite the one surface, or part along the one surface) 17B opposite the one surface 17A. The display panel 17 is, for example, a liquid-crystal display panel. Alternatively, however, it may be of another type, such as a plasma display panel, organic electroluminescent display panel, plastic display panel, sheet display panel, etc. The display panel 17 is electrically connected to the system substrate 15.

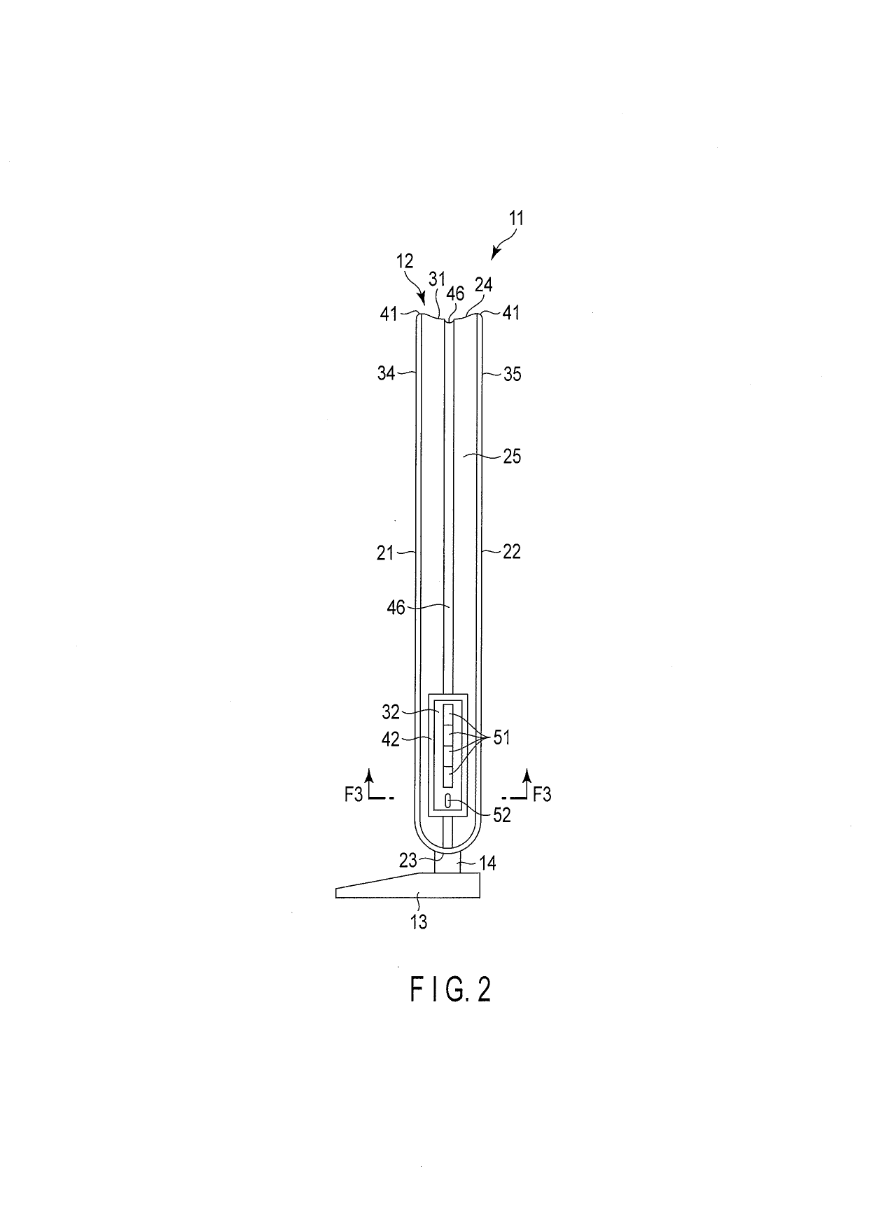

As shown in FIGS. 1 and 2, the cabinet 12 is in the form of a box comprising a first face (front face) 21 along the one surface 17A, second face (rear face) 22 along the other surface 17B, third face (bottom face) 23, fourth face (top face) 24, fifth face (right-hand side face) 25, and sixth face (left-hand side face) 26. The third face 23 longitudinally extends such that it is continuous with the first and second faces 21 and 22. The fourth face 24 faces the third face 23 such that it is continuous with the first and second faces 21 and 22 in a position different from that of the third face 23. The fifth face 25 is continuous with the first to fourth faces 21 to 24. The sixth face 26 faces the fifth face 25 such that it is continuous with the first to fourth faces 21 to 24.

The third face 23 projects outward from the first and second faces 21 and 22 and have an arcuate or curved cross-section. In other words, the third face 23 bulges outward from inside the cabinet 12, has its central part located outside its opposite side faces, has a non-flat face, or comprises a projecting portion.

The fourth face 24 comprises a first recess (opening or hollow) 31 recessed inward from the first and second faces 21 and 22. The fifth face 25 partially comprises a second recess (opening, hollow, or part between walls) 32 recessed inward. The sixth face 26 comprises a third recess (opening or hollow) 33 recessed inward. In other words, each of these recessed portions is retracted inward from outside the cabinet 12, has its central part located inside its opposite side faces, has a non-flat face different from the third face 23, or projects at opposite ends.

The system substrate (printed circuit board) 15 is disposed near the third face 23 within the cabinet 12 (or in a position nearer to the third face 23 than to the other surface or a position where the side faces of the substrate partially face the inner surface of the third face 23). Thus, the system substrate 15 is located near the arcuate third face 23 that easily disperses stress and cannot be easily broken when externally jolted.

The cabinet 12 further comprises first edge portions (end portions, side portions, peripheral portions, edges, projecting portions, projections, parts of wall portions, or extending portions) 41, second edge portion (end portion, side portion, peripheral portion, edge, projecting portion, projection, part of a wall portion, or extending portion) 42, and third edge portions (end portions, side portions, peripheral portions, edges, projecting portions, projections, parts of wall portions, or extending portions) 43. The first to third edge portions 41 to 43 define the peripheries of the first to third recesses 31 to 33, respectively. In the present embodiment, in particular, the second edge portion 42 is in the form of a frame (FIG. 2) that surrounds the second recess 32, a plurality of control buttons (operating unit, buttons, input unit, input receiving unit, receiving unit, or displacement part) 51, and a power button (operating unit, button, input unit, input receiving unit, receiving unit, or displacement part) 52.

As shown in FIGS. 1 to 3, the first to third edge portions 41 to 43 are slanted so that corners (angles) between the first face 21 and the fourth to sixth faces 24 to 26 and corners (angles) between the second face 22 and the fourth to sixth faces 24 to 26 are removed (eliminated to provide substantially flat or curved faces).

The cabinet 12 comprises a first case (first member or component) 34, second case (second member or component) 35, and a plurality of fixing members (fixing portions, components, or junctions) 36. The first case 34 comprises the first face 21 and is fixedly fitted with the display panel 17. The second case 35 comprises the second face 22 and can be attached to and removed from the first case 34 along the second face 22. The fixing members 36 secure the first and second cases 34 and 35 to each other. The first case 34 comprises a case body 34A and an intermediate member (third member or mounting portion) 34B removably attached to the case body 34A. The display panel 17 is sandwiched between the case body 34A and intermediate member 34B.

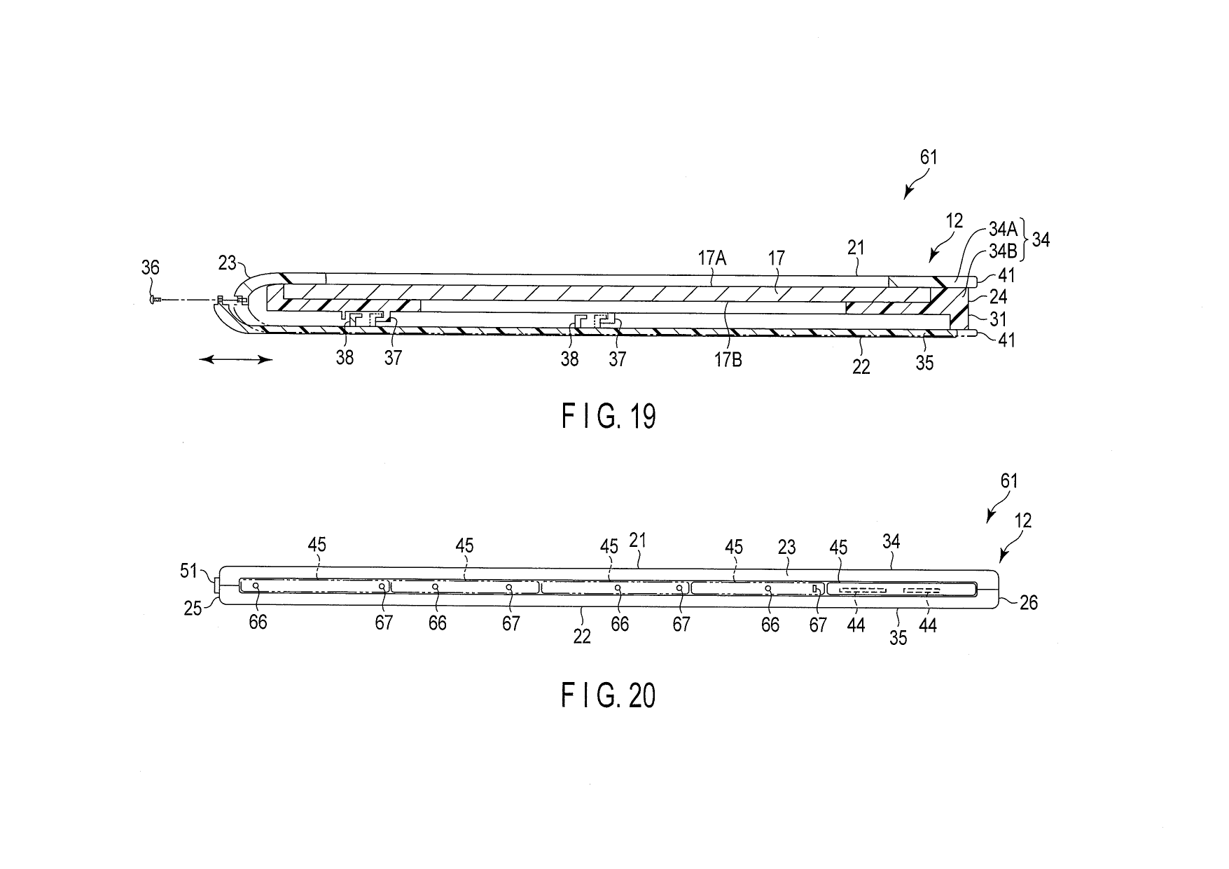

The fixing members 36 are attached to the third face 23 along the second face 22 (FIG. 19). Each of the fixing members 36 may be, for example, a screw, engaging claw, hook, or other component or member. As in the third embodiment shown in FIG. 19, the first case 34 comprises first engaging portions 37. The second case 35 comprises second engaging portions 38 capable of engaging with the first engaging portions 37 along the second face 22. As shown in FIG. 1, moreover, the cabinet 12 comprises first holes (openings, holes, accommodating portions, or socket portions) 44 for a plurality of slots, which are disposed in the third face 23 and into which a recording medium and identification card are to be inserted, and a plurality of decorative members (decorative plates, covering portions, cover portions, design portions, part of the cabinet, or part of the external member) 45. The decorative members 45 are attached to the third face 23 such that they cover the fixing members 36 and first holes 44. As in the third embodiment shown in FIGS. 2, 9 and 11, the cabinet 12 comprises a hollow (recessed portion, retracted portion, or part lower than the other part) 46 further recessed from the first to third recesses 31 to 33 such that it spans between the recesses 31 to 33.

As shown in FIGS. 1 to 3, the television 11 comprises the control buttons 51 arranged side by side in the second recess 32 and power button 52 located in line with the control buttons 51 in the second recess 32. The television 11 further comprises a label 53, which is disposed in the third recess 33 and carries management data (information), a speaker 54 disposed in the cabinet 12, and a plurality of openings 55 arranged near the speaker 54 in the third recess 33. The control buttons 51, power button 52, and switch substrate 16 constitute a receiving portion, which is electrically connected to the system substrate 15 and receives an external operation input. The second recess 32 comprises an opening 39 through which the receiving portion constructed in this manner is externally exposed.

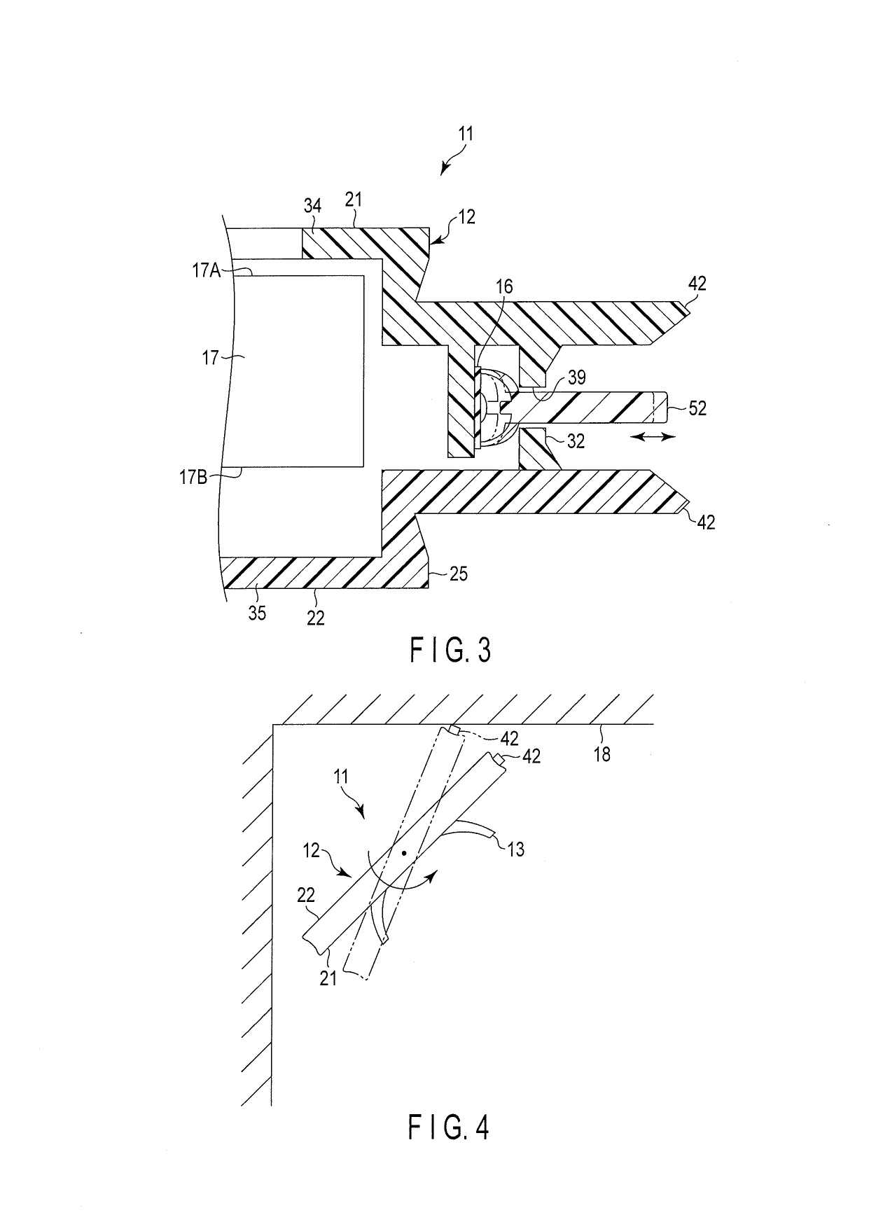

The power button 52 is located deeper in the cabinet 12 than the control buttons 51. As shown in FIG. 3, the power button 52 can be moved across the fifth face 25 and contact the switch substrate 16 when in its pushed-in position, thereby switching the television 11 on or off. The power button 52 in its normal position is located deeper in the cabinet 12 than the second edge portion 42 by a very short distance (for example, approximately 0.1 to several millimeters). The power button 52 is disposed near the third face 23 and spaced apart from the control buttons 51. The power button 52 is oblong and comprises an arcuate portion shaped to resemble the arcuate third face 23.

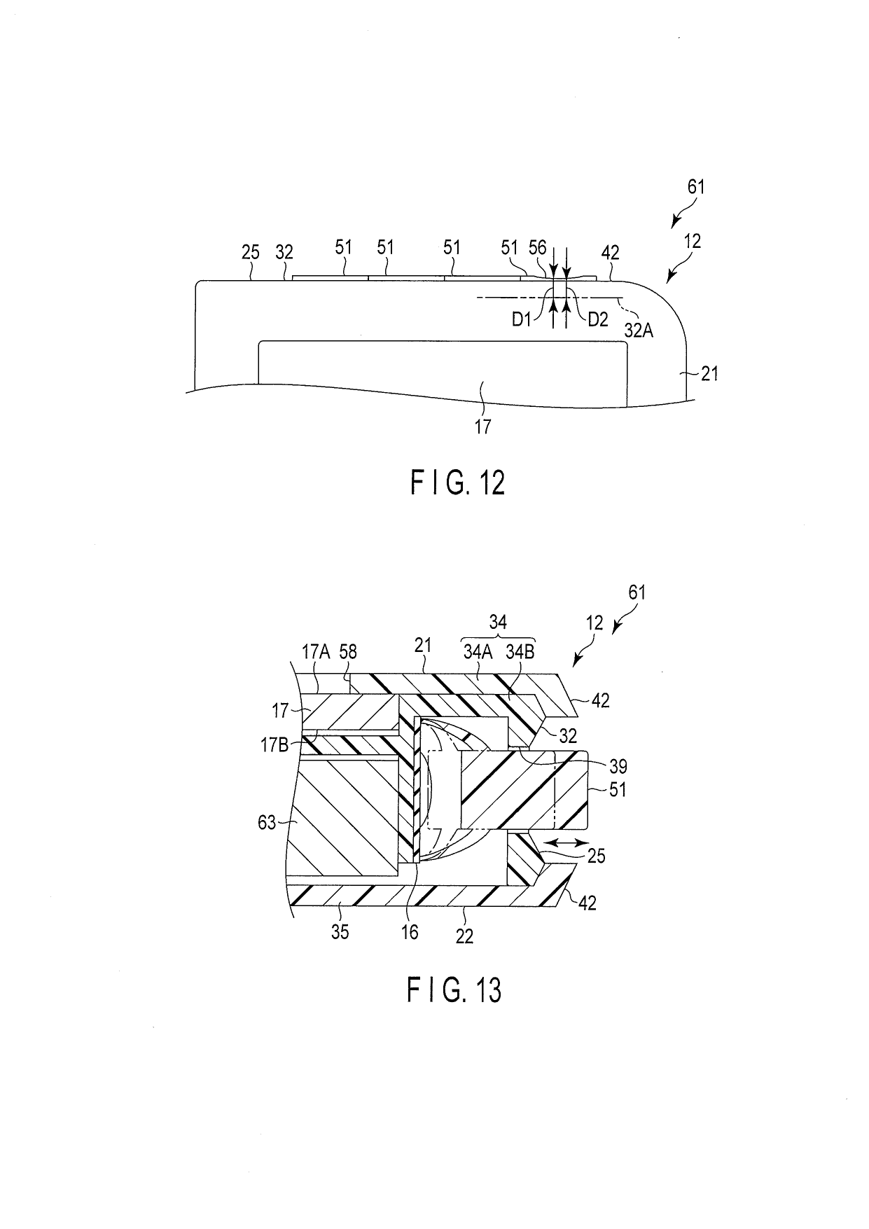

In the present embodiment, the control buttons 51 are, for example, four in number and include a menu button, channel button, channel return button, and volume control button. Each of the control buttons 51 can be moved (or displaced) across the fifth face 25 and contact the switch substrate 16 when in its pushed-in position, thereby variously operating the television 11. Each control button 51 in its normal position projects a very short distance (for example, approximately 0.1 to several millimeters) outside the second edge portion 42 (first and second faces 21 and 22). Each control button 51 is located deeper in the cabinet 12 than the second edge portion 42 when in its depressed position. The control button 51 that serves as the volume control button comprises a depression 56 contoured to fit the shape of a fingertip and a pair of end portions 57 around the depression 56. The end portions 57 correspond individually to different operations, that is, operations for turning the volume up and down. As in the third embodiment shown in FIG. 12, distance D1 between the depression 56 and a plane 32A that passes through the bottom of the second recess 32 is substantially equal to distance D2 between the plane 32A and second edge portion 42.

The television 11 of the present embodiment is configured to reduce the possibility of a malfunction caused by erroneous pressing of any of the control buttons 51 and power button 52. Specifically, as shown in FIG. 4, when the television 11 is horizontally turned by means of the swivel portion 14, the second edge portion 42 first contacts a wall 18, thereby preventing the control buttons 51 and power button 52 from being erroneously depressed. As for the influential power button 52, in particular, it is located deeper in the cabinet 12 than the second edge portion 42, so that the possibility of its being erroneously depressed is considerably reduced.

According to the first embodiment, the television 11 comprises the display panel 17, which comprises the one surface 17A and the other surface 17B opposite the one surface 17A, and the cabinet 12 accommodating the display panel 17. The cabinet 12 comprises the first face 21 along the one surface 17A, second face 22 along the other surface 17B, third face 23 longitudinally extending such that it is continuous with the first and second faces 21 and 22 and projecting outward, and fourth face 24 facing the third face 23 such that it is continuous with the first and second faces 21 and 22 and comprising the inwardly recessed first recess 31.

According to this configuration, the television 11 can be made book-like as a whole and improved in appearance.

The television 11 comprises the fifth face 25, which is disposed on the cabinet 12 so as to be continuous with the first to fourth faces 21 to 24 and comprises the inwardly recessed second recess 32, control buttons 51 arranged side by side in the second recess 32, and power button 52 located in line with the control buttons 51 in the second recess 32. Since the control buttons 51 and power button 52 are arranged in the second recess 32, according to this configuration, they can be made hard to see from the side of the first face 21. Thus, the appearance of the television 11 can be improved, and the operability can also be improved by means of the control buttons 51 and power button 52.

In the present embodiment, the power button 52 is located deeper in the cabinet 12 than the control buttons 51. According to this configuration, the possibility of the power button 52 being erroneously depressed and erroneously switching power on or off can be reduced.

The power button 52 is movable across the fifth face 25, and when in its normal position, is located deeper in the cabinet 12 than the second edge portion 42 that defines the periphery of the second recess 32. According to this configuration, the possibility of the power button 52 being erroneously depressed can be further reduced, and influences on the television 11 and its peripheral equipment in operation can be reduced.

In this case, the third face 23 has an arcuate cross-section. According to this configuration, the appearance of the television 11 can be improved. The power button 52 has an oblong shape similar to that of the third face 23. According to this configuration, the power button 52 can be located as close to the third face 23 as possible, whereby the utilization efficiency of the space in the cabinet 12 can be improved.

The television 11 comprises the printed circuit board disposed near the third face 23 within the cabinet 12. According to this configuration, the printed circuit board can be located near the third face 23 with an arcuate cross-section that is less susceptible to stress concentration or easily disperses stress. Thus, even if the television 11 is externally jolted, the printed circuit board, as well as the cabinet 12, can be prevented from being broken in the vicinity of the third face 23.

In the present embodiment, the control buttons 51 are movable across the fifth face 25, and when in their normal position, are located outer than the second edge portion 42 by a very short distance. Even though the control buttons 51 are not fully located inside the second edge portion 42 within the cabinet 12, as in this configuration, for example, protection of the control buttons 51 by the second edge portion 42 can be expected to a certain degree. According to the configuration described above, prevention of erroneous operation of the control buttons 51 can be reconciled with attainment of satisfactory user-friendliness.

The control buttons 51 in the depressed position are located deeper in the cabinet 12 than the second edge portion 42. According to this configuration, a user's finger or the like abuts and stops against the second edge portion 42 when it depresses any of the control buttons 51. Even if the button is pressed with great force by the user, therefore, the possibility of its being broken by overpressure can be reduced.

One of the control buttons 51 comprises the depression 56 contoured to fit the shape of a fingertip and the pair of end portions 57 around the depression 56. The end portions 57 correspond individually to different operations. According to this configuration, two operations can be performed by means of a single button. Thus, the number of control buttons 51 can be reduced to achieve cost reduction, and the cabinet 12 can be miniaturized.

Distance D1 between the depression 56 and the plane 32A that passes through the bottom of the second recess 32 is substantially equal to distance D2 between the plane 32A and second edge portion 42. According to this configuration, a fingertip can be easily guided into the depression 56, so that the control button 51 can be operated with the fingertip in the depression 56. Thus, operability can be improved.

The television 11 comprises the sixth face 26, which is disposed on the cabinet 12, faces the fifth face 25 such that it is continuous with the first to fourth faces 21 to 24, and comprises the inwardly recessed third recess 33, and the label 53, which is disposed in the third recess 33 and carries data. According to this configuration, the label 53 is set in such a position that it cannot be easily peeled off the cabinet 12. Thus, the label 53 can be prevented from unexpectedly separating from the cabinet 12.

The television 11 comprises the speaker 54 disposed in the cabinet 12 and the openings 55 arranged near the speaker 54 in the third recess 33. According to this configuration, the openings 55 through which sound from the speaker 54 is emitted can be prevented from being closed even if the television 11 is placed such that the sixth face 26 contacts a wall or the like.

The cabinet 12 comprises: the first case 34 which comprises the first face 21 and to which the display panel 17 is secured; the second case 35 which comprises the second face 22 and is attachable/detachable to or from the first case 34 in the direction along the second face 22; and the fixing members 36 that extend in the direction along the second face 22 and secure the first and second cases 34 and 35 to each other. According to this configuration, the thickness of the cabinet 12 can be reduced by arranging the fixing members 36 along the second face 22.

The cabinet 12 comprises the hollow 46 that is further recessed from the first to third recesses 31 to 33 such that it spans between the recesses 31 to 33. According to this configuration, the appearance of the cabinet 12 can be improved and the thinness of the cabinet can be accentuated.

The first to third edge portions 41 to 43 are slanted so that the corners between the first face 21 and the fourth to sixth faces 24 to 26 and the corners between the second face 22 and the fourth to sixth faces 24 to 26 are removed. According to this configuration, the cabinet 12 can be improved in appearance by being rounded and made to look thinner. Since the fourth face 24 is a top face, moreover, it can be easily cleaned if dust or the like is accumulated on it.

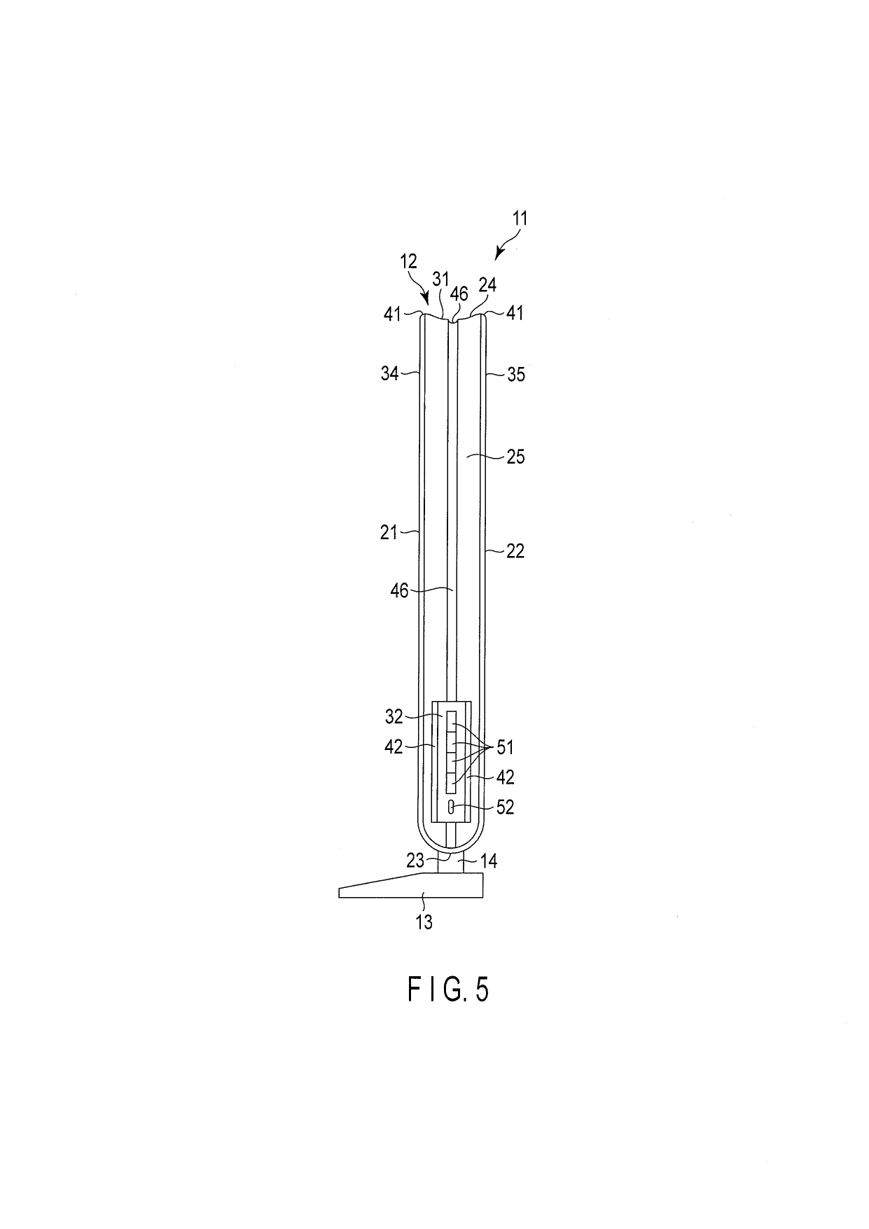

Referring now to FIG. 5, a second embodiment of the electronic apparatus will be described. A television 11 as an example of the electronic apparatus according to the second embodiment differs from the television of the first embodiment in the configuration of the second edge portion 42, and substantially shares the configurations of other parts in common with the first embodiment. Therefore, only those portions which are different from their counterparts in the first embodiment will be described. Common numbers are used to designate common portions of these embodiments, and a description of those portions is omitted.

A cabinet 12 comprises a first face (front face) 21, second face (rear face) 22, third face (bottom face) 23, fourth face (top face) 24, fifth face (right-hand side face) 25, and sixth face (left-hand side face) 26.

The fourth face 24 comprises an inwardly recessed first recess 31. The fifth face 25 partially comprises an inwardly recessed second recess 32. The sixth face 26 comprises an inwardly recessed third recess 33.

The cabinet 12 further comprises first edge portions 41, second edge portions 42, and third edge portions 43. The first to third edge portions 41 to 43 define the peripheries of the first to third recesses 31 to 33, respectively. In the present embodiment, the second edge portions 42 are in the form of two linear ridges extending longitudinally relative to the second recess 32. A plurality of control buttons 51 and a power button 52 are arranged between these two ridges.

The power button 52 is located deeper in the cabinet 12 than the control buttons 51. The power button 52 in its normal position is located deeper in the cabinet 12 than the second edge portions 42 by a very short distance (for example, approximately 0.1 to several millimeters). The power button 52 is disposed near the third face 23 and spaced apart from the control buttons 51. The power button 52 is oblong and comprises an arcuate portion shaped to resemble the arcuate third face 23.

In the present embodiment, the control buttons 51 are four in number and include a menu button, channel button, channel return button, and volume control button. Each of the control buttons 51 in its normal position projects a very short distance (approximately 0.1 to several millimeters) outside the second edge portions 42. Each control button 51 is located deeper in the cabinet 12 than the second edge portions 42 when in its depressed position. The control button 51 that serves as the volume control button comprises a depression 56 contoured to fit the shape of a fingertip and a pair of end portions 57 around the depression 56. As in the third embodiment shown in FIG. 12, distance D1 between the depression 56 and a plane 32A that passes through the bottom of the second recess 32 is substantially equal to distance D2 between the plane 32A and each second edge portion 42.

Also in the structure of the second embodiment, protection of the control buttons 51 by the second edge portions 42 can be expected to a certain degree. According to the configuration described above, moreover, prevention of erroneous operation of the control buttons 51 can be reconciled with attainment of satisfactory user-friendliness.

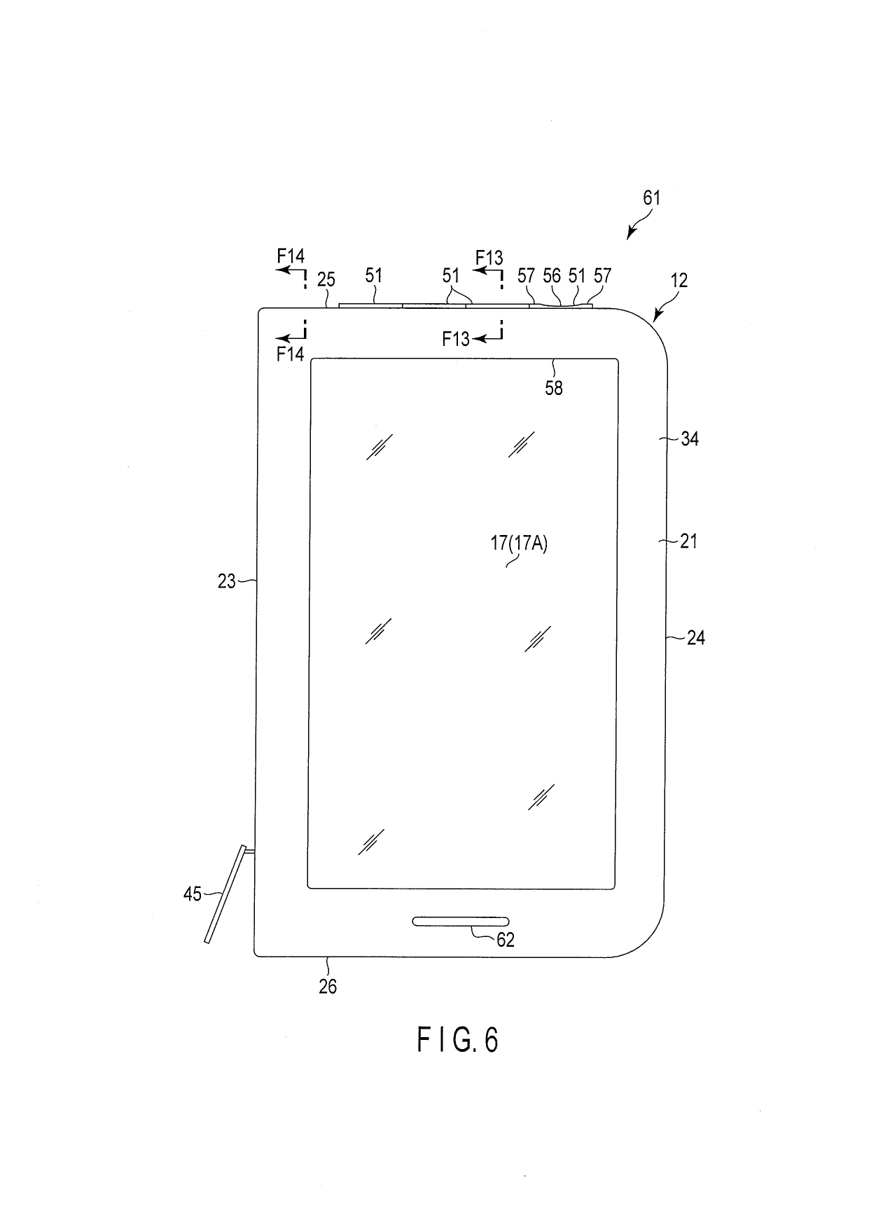

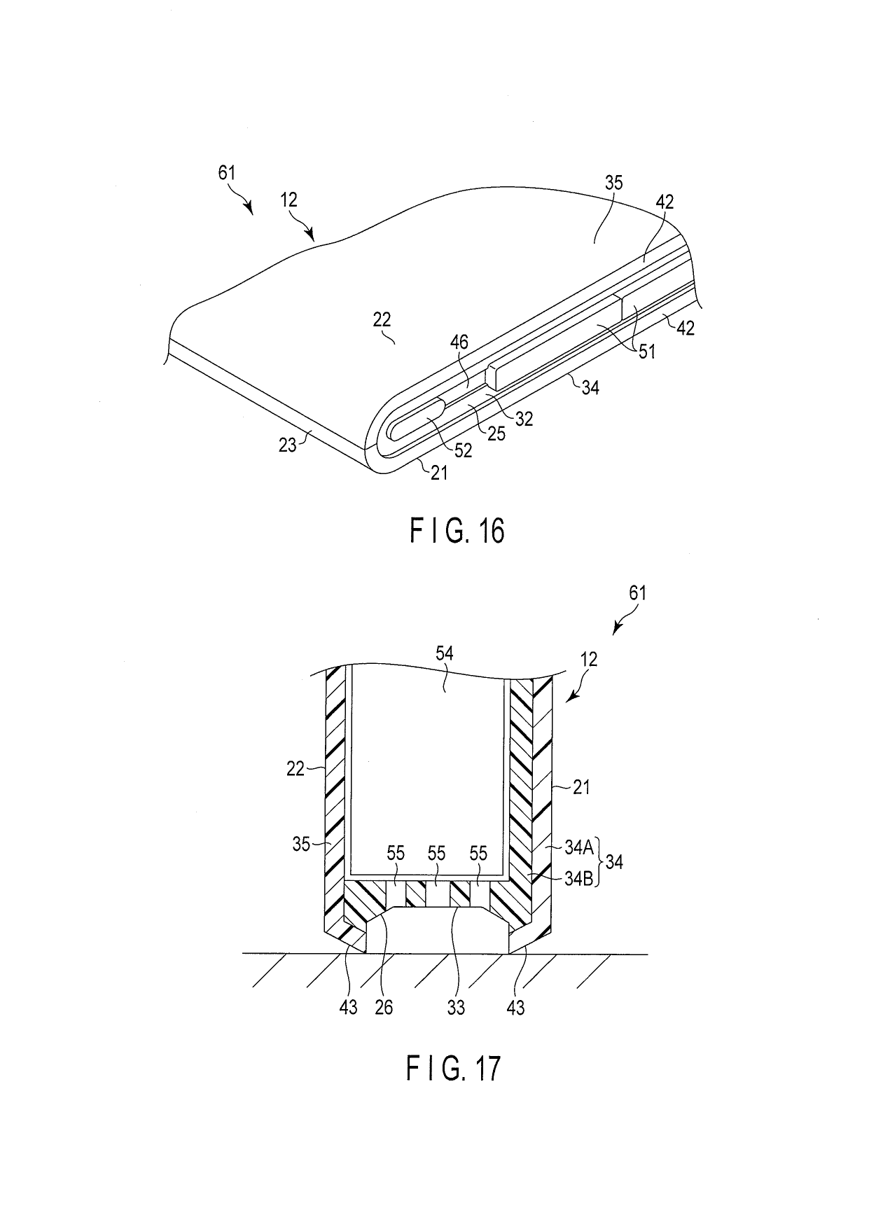

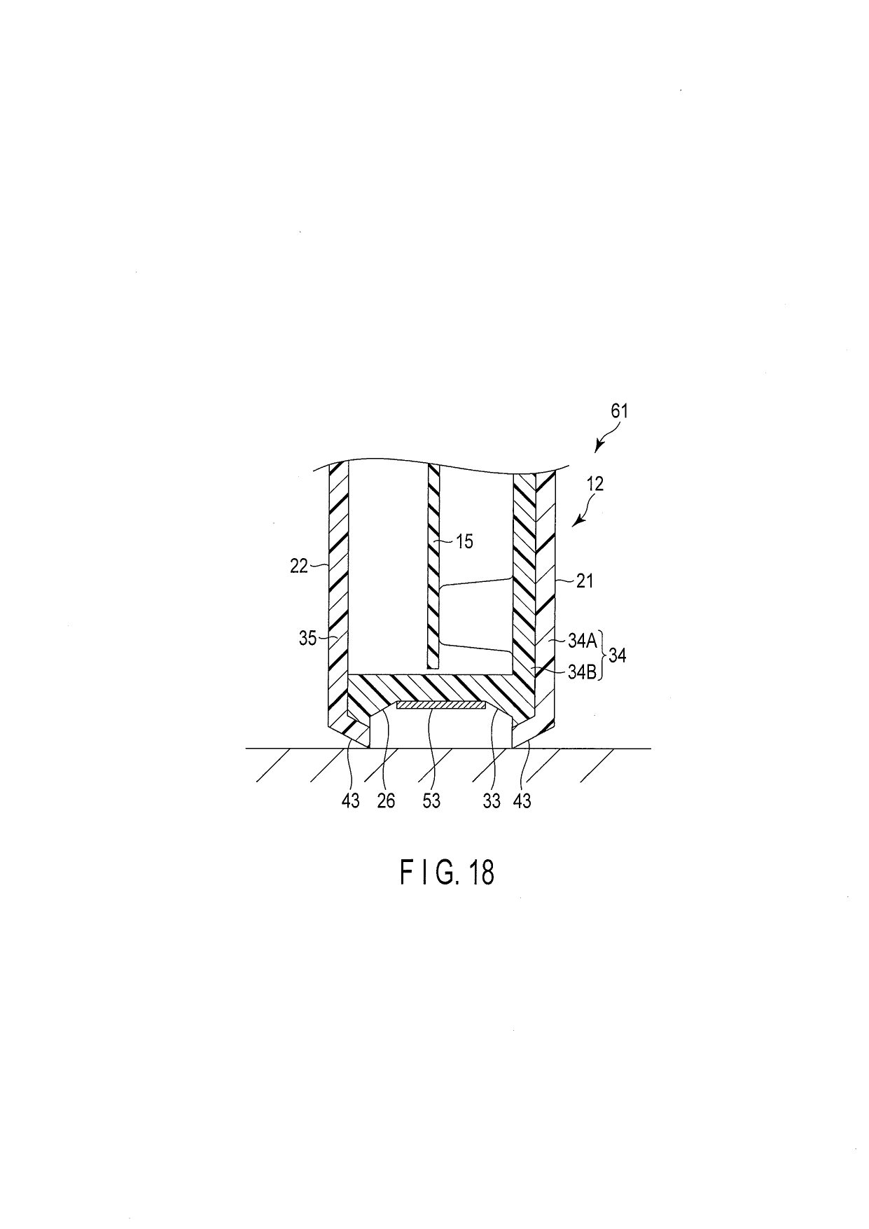

Referring now to FIGS. 6 to 20, the third embodiment of the electronic apparatus will be described. A portable computer (tablet computer) 61 as an example of the electronic apparatus according to the third embodiment differs from the television of the first embodiment in external appearance, and substantially shares the principal configuration in common with the first embodiment. Therefore, only those portions which are different from their counterparts in the first embodiment will be described. Common numbers are used to designate common portions of these embodiments, and a description of those portions is omitted.

As shown in FIG. 6, the portable computer 61 comprises a cabinet (housing, case, shell, external member, protective member, or part) 12 in the form of, for example, a plastic box, display panel 17 in the form of a flat plate (having a sheet-like or flat face), and home button 62 (button) 62. The display panel 17 is accommodated in the cabinet 12 and comprises one surface (surface, face, part, or region) 17A and the other surface (surface, face, part, region, part opposite the one surface, or part along the one surface) 17B opposite the one surface 17A. The home button 62 is disposed on a part of the cabinet 12. The home button 62 is used to restore, for example, a picture displayed on the display panel 17 to its initial state. The display panel 17 is, for example, a liquid-crystal display panel. Alternatively, however, it may be of another type, such as a plasma display panel, organic electroluminescent display panel, plastic display panel, sheet display panel, etc. The one surface 17A is a display screen on which an image is displayed. The display panel 17 is electrically connected to a printed circuit board 15.

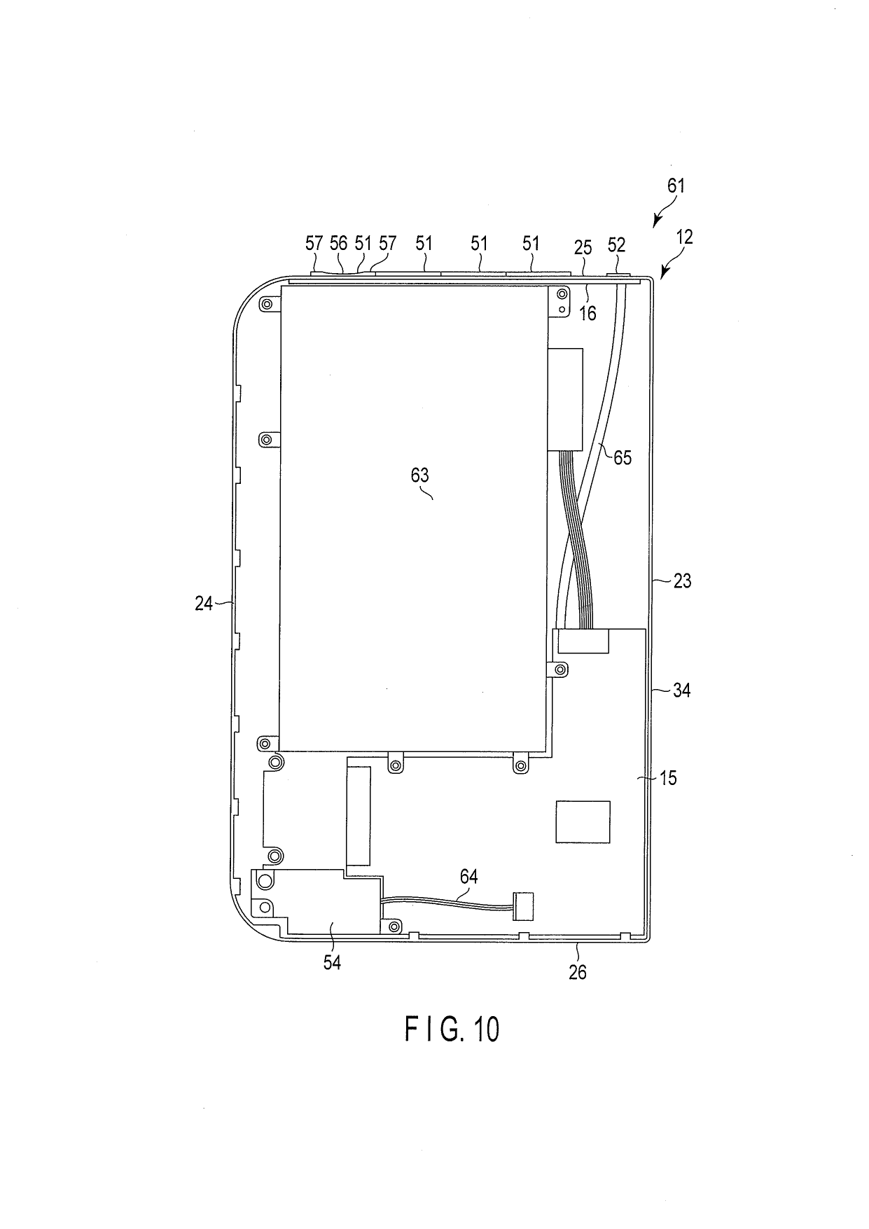

As shown in FIG. 10, the portable computer 61 comprises the printed circuit board (system substrate, substrate, electronic component, component, system section, or control section) 15, a battery 63, a speaker 54, and a switch substrate (printed circuit board, substrate, electronic component, component, switch section, or system substrate control section) 16, which are all accommodated in the cabinet 12. A plurality of circuit components, including a CPU, are mounted on the printed circuit board 15. The battery 63 supplies electric power to the printed circuit board 15 and other components. The speaker 54 is connected to the printed circuit board 15 by a first cable 64. The switch substrate 16 is electrically connected to the printed circuit board 15 by a second cable 65. The cabinet 12 of the portable computer 61 may be designed to accommodate therein the tuner substrate (printed circuit board, substrate, electronic component, component, tuner section, tuner device, or tuner control section) 19 of the first embodiment.

As shown in FIGS. 6 to 9, the cabinet 12 is in the form of a box comprising a first face (front face) 21 along the one surface 17A, second face (rear face) 22 along the other surface, third face (left-hand side face) 23, fourth face (right-hand side face) 24, fifth face (top face) 25, and sixth face (bottom face) 26. The third face 23 longitudinally extends such that it is continuous with the first and second faces 21 and 22. The fourth face 24 faces the third face 23 such that it is continuous with the first and second faces 21 and 22 in a position different from that of the third face 23. The fifth face 25 is continuous with the first to fourth faces 21 to 24. The sixth face 26 faces the fifth face 25 such that it is continuous with the first to fourth faces 21 to 24.

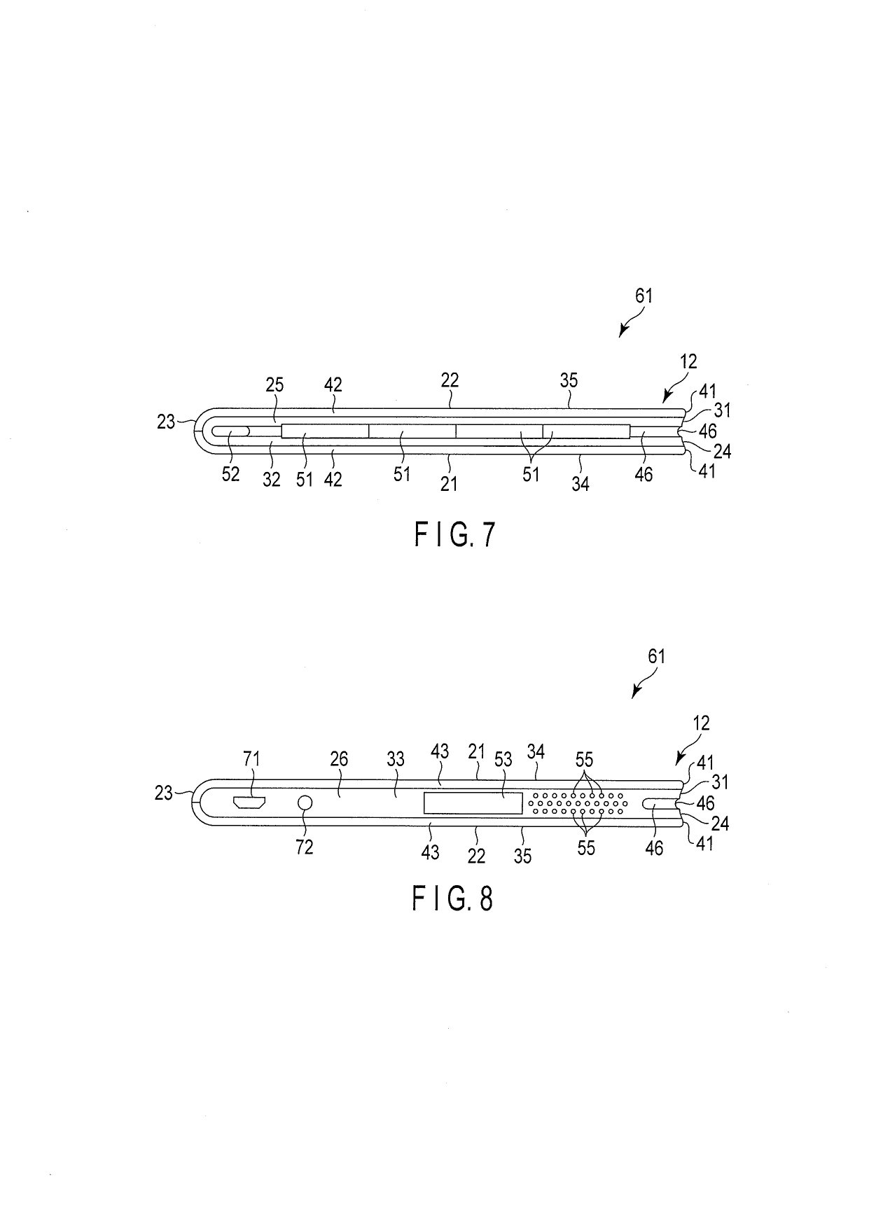

The third face 23 projects outward from the first and second faces 21 and 22 and have an arcuate or curved cross-section (FIG. 7). In other words, the third face 23 bulges outward from inside the cabinet 12, has its central part located outside its opposite side faces, has a non-flat face, or comprises a projecting portion. Thus, the third face 23 of the cabinet 12 projects in a circular arc such that a user can easily hold the cabinet in the left hand.

The fourth face 24 comprises a first recess (opening or hollow) 31 recessed inward from the first and second faces 21 and 22. The fifth face 25 comprises a second recess (opening, hollow, or part between walls) 32 recessed inward. The sixth face 26 comprises a third recess (opening or hollow) 33 recessed inward. In other words, each of these recessed portions is retracted inward from outside the cabinet 12, has its central part located inside its opposite side faces, has a non-flat face different from the third face 23, or projects at opposite ends.

The printed circuit board 15 is disposed near the third face 23 within the cabinet 12 (or in a position nearer to the third face 23 than to the other surface or a position where the side faces of the substrate partially faces the inner surface of the third face 23). Thus, the printed circuit board 15 is located near the arcuate third face 23 that easily disperses stress and cannot be easily broken when externally jolted.

The cabinet 12 further comprises first edge portions (end portions, side portions, peripheral portions, edges, projecting portions, projections, parts of wall portions, or extending portions) 41, second edge portions (end portions, side portions, peripheral portions, edges, projecting portions, projections, parts of wall portions, or extending portions) 42, and third edge portions (end portions, side portions, peripheral portions, edges, projecting portions, projections, parts of wall portions, or extending portions) 43. The first to third edge portions 41 to 43 define the peripheries of the first to third recesses 31 to 33, respectively. In other words, the first recess 31 is located between the first edge portions 41, the second recess 32 between the second edge portions 42, and the third recess 33 between the third edge portions 43.

As shown in FIGS. 7, 9, 13, 14, 17 and 18, the first to third edge portions 41 to 43 are slanted so that corners (angles) between the first face 21 and the fourth to sixth faces 24 to 26 and corners (angles) between the second face 22 and the fourth to sixth faces 24 to 26 are removed (eliminated to provide substantially flat or curved faces).

As shown in FIG. 19, the cabinet 12 comprises a first case (first member or component) 34, second case (second member or component) 35, and a plurality of fixing members (fixing portions, components, or junctions) 36. The first case 34 comprises the first face 21 and is fixedly fitted with the display panel 17. The second case 35 comprises the second face 22. The fixing members 36 secure the first and second cases 34 and 35 to each other. As shown in FIG. 6, the first case 34 comprises a rectangular opening 58 through which the display panel 17 is externally exposed.

The first case 34 comprises a case body 34A and an intermediate member (third member or mounting portion) 34B removably attached to the case body 34A. The display panel 17 is sandwiched between the case body 34A and intermediate member 34B. As shown in FIG. 19, the second case 35 can be attached to and removed from the first case 34 along the second face 22.

As shown in FIGS. 19 and 20, the fixing members 36 are attached to the third face 23 along the second face 22. Each of the fixing members 36 may be, for example, a screw, engaging claw, hook, or other component or member. As shown in FIG. 20, the cabinet 12 comprises, in its third face 23, fixing holes 66 to which the fixing members 36 are secured and mounting holes 67 to which decorative members 45 (described later) are secured.

As shown in FIG. 19, the first case 34 comprises hooked first engaging portions 37. Although the first engaging portions 37 are two in number according to the present embodiment, one or three or more first engaging portions may alternatively be used. The second case 35 comprises similarly hooked second engaging portions 38 capable of engaging with the first engaging portions 37 along the second face 22. Although the second engaging portions 38 are two in number according to the present embodiment, one or three or more second engaging portions may alternatively be used.

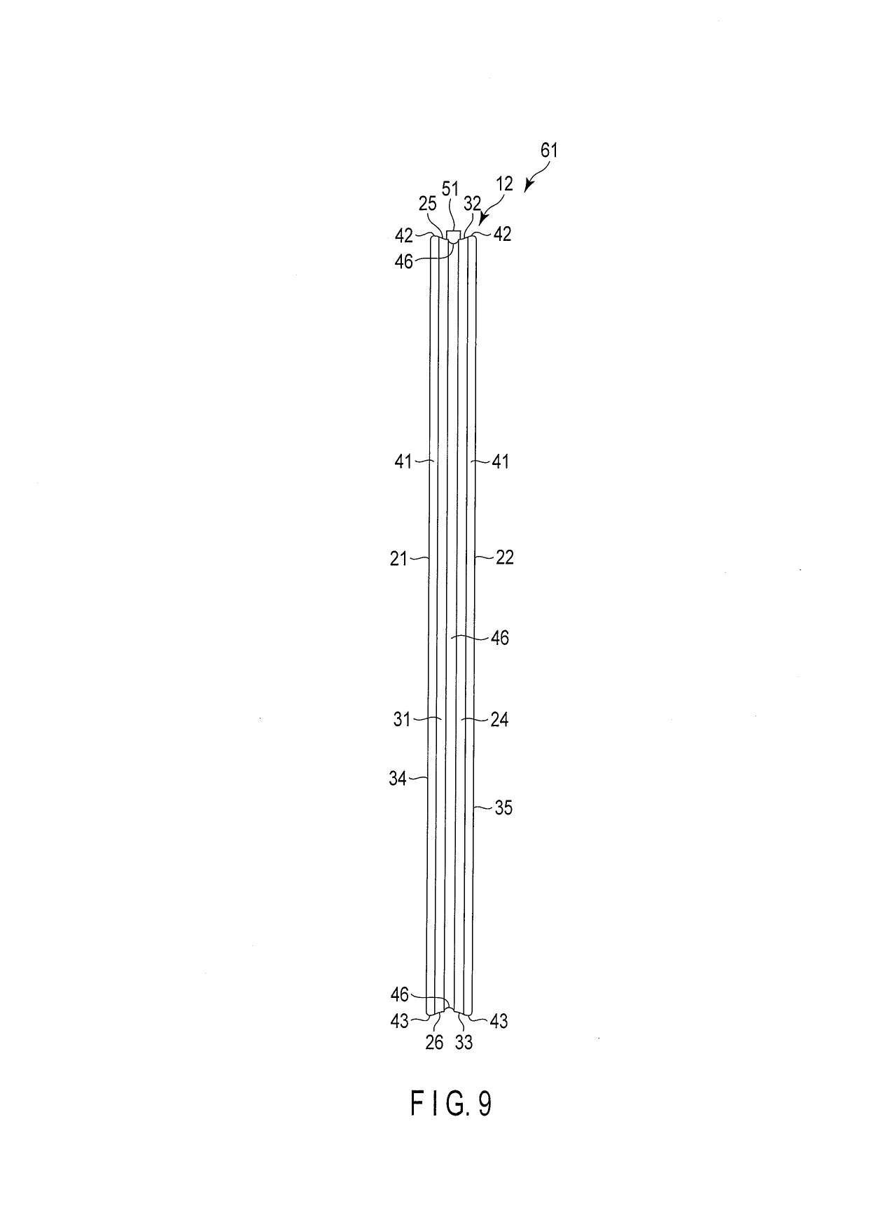

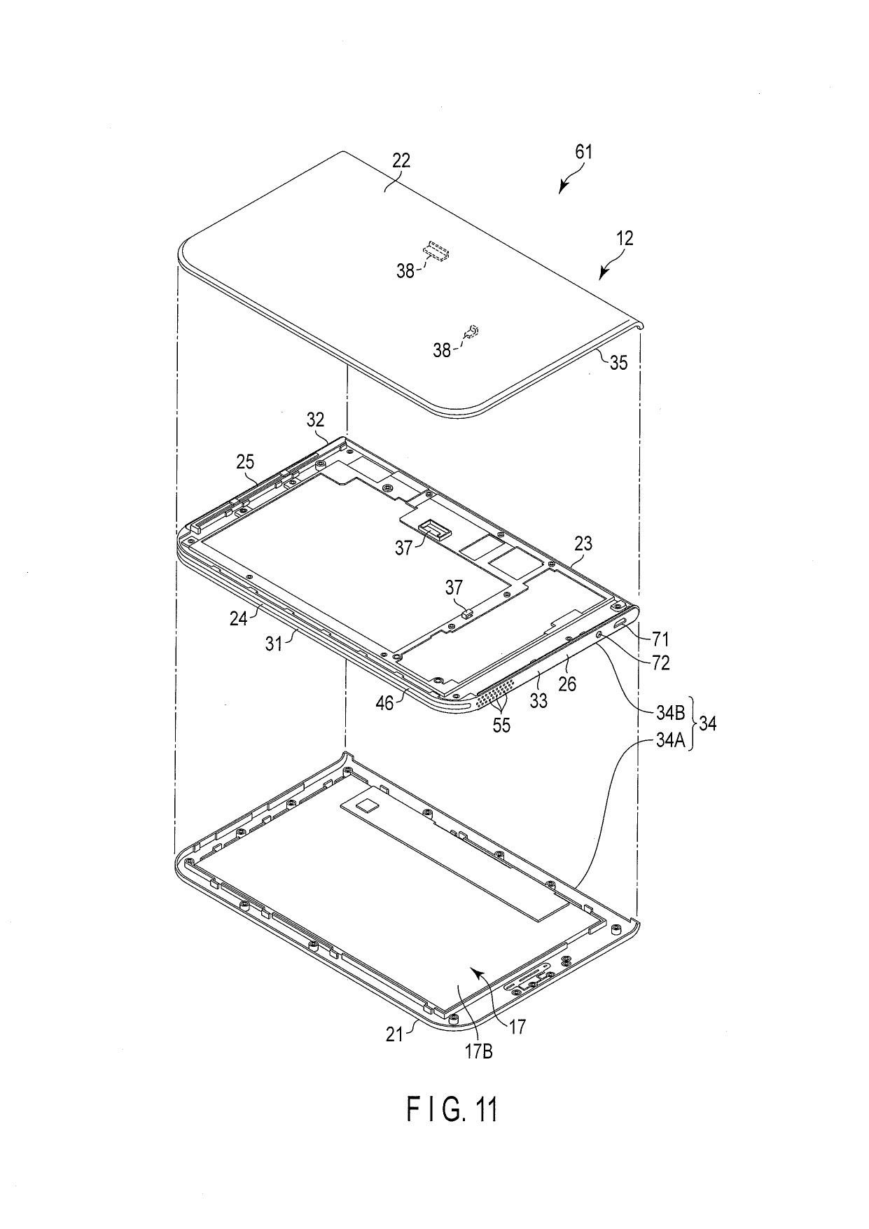

As shown in FIGS. 8 and 20, the cabinet 12 comprises first holes (openings, holes, accommodating portions, or socket portions) 44 for a plurality of slots, which are disposed in the third face 23 and into which a recording medium and identification card are to be inserted, and a plurality of decorative members (decorative plates, covering portions, cover portions, design portions, part of the cabinet, or part of the external member) 45. The decorative members 45 are attached to the third face 23 such that they cover the fixing members 36 and first holes 44. The cabinet 12 further comprises a second hole 71 for a second slot, which is disposed in the sixth face 26 and into which a recording medium is to be inserted, and a third hole 72 for a jack, which is disposed in the sixth face 26 and into which a headphone plug is to be inserted. As shown in FIGS. 9 and 11, the cabinet 12 comprises a hollow (recessed portion, retracted portion, or part lower than the other part) 46 further recessed from the first to third recesses 31 to 33 such that it spans between the recesses 31 to 33.

The portable computer 61 comprises a plurality of control buttons (operating unit, buttons, input unit, input receiving unit, receiving unit, or displacement part) 51, arranged side by side in the second recess 32, and power button (operating unit, button, input unit, input receiving unit, receiving unit, or displacement part) 52 located in line with the control buttons 51 in the second recess 32. The portable computer 61 further comprises a label 53, which is disposed in the third recess 33 and carries production management data (information), such as a serial number, and a plurality of openings 55 arranged near the speaker 54 in the third recess 33. The control buttons 51, power button 52, and switch substrate 16 constitute a receiving portion, which is electrically connected to the printed circuit board 15 and receives an external operation input. The second recess 32 comprises an opening 39 through which the receiving portion constructed in this manner is externally exposed.

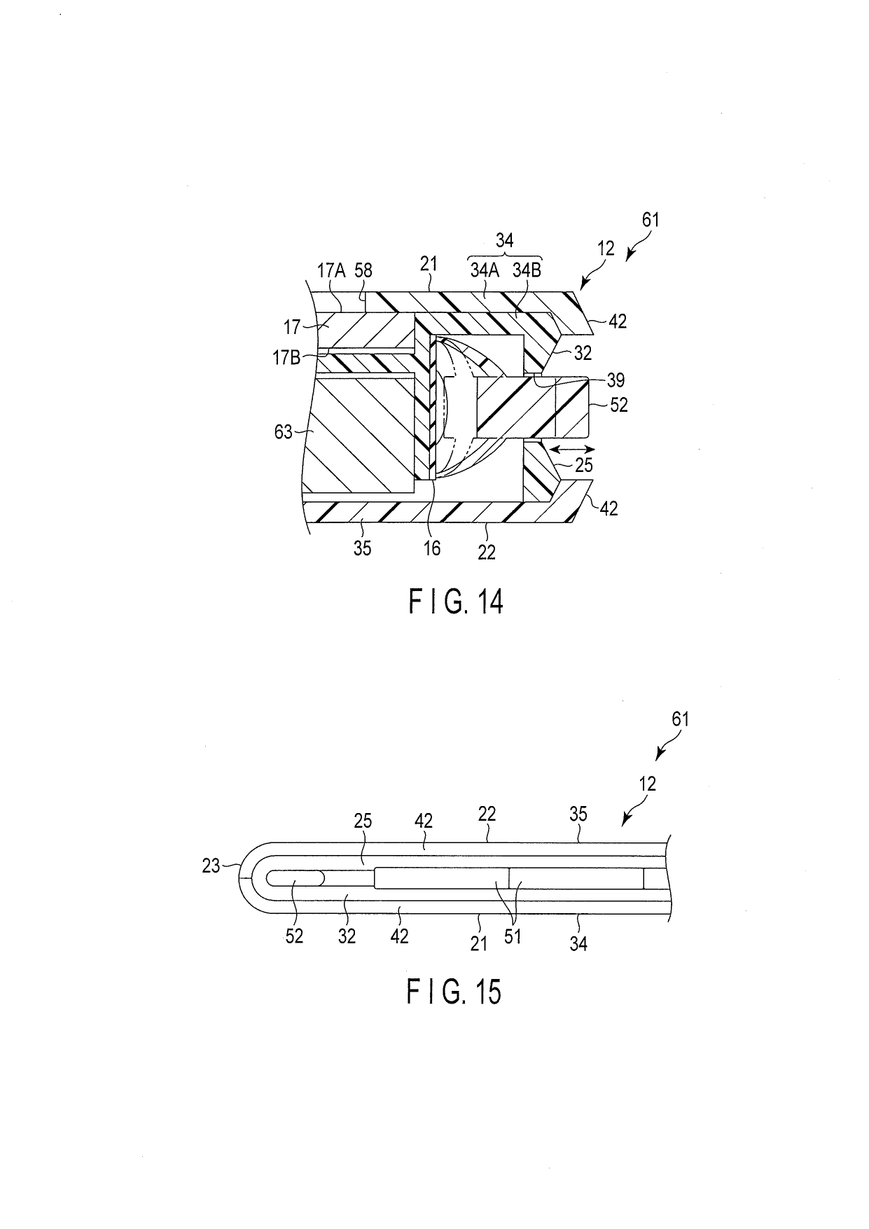

The power button 52 is located deeper in the cabinet 12 than the control buttons 51. As shown in FIG. 14, the power button 52 can be moved (or displaced) across the fifth face 25 and contact the switch substrate 16 when in its pushed-in position, thereby switching the portable computer 61 on or off. The power button 52 in its normal position is located deeper in the cabinet 12 than the second edge portion 42 by a very short distance (for example, approximately 0.1 to several millimeters). As shown in FIG. 16, the power button 52 is disposed near the third face 23 (or in the vicinity of an end portion of the fifth face 25) and spaced apart from the control buttons 51. As shown in FIG. 16, the power button 52 is oblong and comprises an arcuate portion shaped to resemble the arcuate third face 23. As shown in FIG. 15, the width of the power button 52 across its length is substantially equal to that of the hollow 46.

In the present embodiment, as shown in FIG. 7, the control buttons 51 are four in number and include a menu button, feed button (page forward button), return button (page return button), and volume control button. As shown in FIG. 13, each of the control buttons 51 can be moved across the fifth face 25 and contact the switch substrate 16 when in its pushed-in position, thereby variously operating the portable computer 61. The intermediate member 34B and battery 63 contact and support the switch substrate 16. Even if the power button 52 or any of the control buttons 51 is erroneously depressed with great force by the user, therefore, the switch substrate 16 can be prevented from being dislocated.

Each of the control buttons 51 in its normal position projects a very short distance (for example, approximately 0.1 to several millimeters) outside the second edge portion 42 (first and second faces 21 and 22). Each control button 51 is located deeper in the cabinet 12 than the second edge portion 42 when in its depressed position. As shown in FIG. 15, the width of each control button 51 across its length is greater than that of the hollow 46 by a very small margin. The stroke of each control button 51 is substantially equal to that of the power button 52.

As shown in FIG. 12, the control button 51 that serves as the volume control button comprises a depression 56 contoured to fit the shape of a fingertip and a pair of end portions 57 around the depression 56. The end portions 57 correspond individually to different operations, that is, operations for turning the volume up and down. As shown in FIG. 12, distance D1 between the depression 56 and a plane 32A that passes through the bottom of the second recess 32 is substantially equal to distance D2 between the plane 32A and second edge portion 42.

According to the third embodiment, the portable computer 61 comprises the display panel 17, which comprises the one surface 17A and the other surface 17B opposite the one surface 17A, and the cabinet 12, which accommodates the display panel 17 and comprises the first face 21 along the one surface 17A, second face 22 along the other surface 17B, third face 23, and fourth face 24. The third face 23 longitudinally extends such that it is continuous with the first and second faces 21 and 22 and projects outward. The fourth face 24 faces the third face 23 such that it is continuous with the first and second faces 21 and 22 and is recessed inward.

According to this configuration, the portable computer 61 can be made book-like as a whole and improved in appearance.

The portable computer 61 comprises the fifth face 25, which is disposed on the cabinet 12 so as to be continuous with the first to fourth faces 21 to 24 and comprises the inwardly recessed second recess 32, control buttons 51 arranged side by side in the second recess 32, and power button 52 located in line with the control buttons 51 in the second recess 32. Since the control buttons 51 and power button 52 are arranged in the second recess 32, according to this configuration, they can be made hard to see from the side of the first face 21. Thus, the appearance of the portable computer 61 can be improved, and the operability can be also improved by means of these buttons.

In the present embodiment, the power button 52 is located deeper in the cabinet 12 than the control buttons 51. According to this configuration, the possibility of the power button 52 being erroneously depressed and erroneously switching power on or off can be reduced.

The power button 52 is movable across the fifth face 25, and when in its normal position, is located deeper in the cabinet 12 than the second edge portion 42 that defines the periphery of the second recess 32. According to this configuration, the possibility of the power button 52 being erroneously depressed can be further reduced, and influences on the portable computer 61 and its peripheral equipment in operation can be reduced.

In this case, the third face 23 has an arcuate cross-section. According to this configuration, the appearance of the portable computer 61 can be improved. The power button 52 has an oblong shape similar to that of the third face 23. According to this configuration, the power button 52 can be located as close to the third face 23 as possible, whereby the utilization efficiency of the space in the cabinet 12 can be improved.

The portable computer 61 comprises the printed circuit board 15 disposed near the third face 23 within the cabinet 12. According to this configuration, the printed circuit board 15 can be located near the third face 23 with an arcuate cross-section that is less susceptible to stress concentration. Thus, even if the portable computer 61 is externally jolted, the printed circuit board 15, as well as the cabinet 12, can be prevented from being broken in the vicinity of the third face 23.

In the present embodiment, the control buttons 51 are movable across the fifth face 25, and when in their normal position, are located outer than the second edge portion 42 by a very short distance. Even though the control buttons 51 are not fully located inside the second edge portion 42 within the cabinet 12, as in this configuration, for example, protection of the control buttons 51 by the second edge portion 42 can be expected to a certain degree. According to the configuration described above, prevention of erroneous operation of the control buttons 51 can be reconciled with attainment of satisfactory user-friendliness.

The control buttons 51 in the depressed position are located deeper in the cabinet 12 than the second edge portion 42. According to this configuration, a user's finger or the like abuts and stops against the second edge portion 42 when it depresses any of the control buttons 51. Even if the button is pressed with great force by the user, therefore, the possibility of its being broken by overpressure can be reduced.

One of the control buttons 51 comprises the depression 56 contoured to fit the shape of a fingertip and the pair of end portions 57 around the depression 56. The end portions 57 correspond individually to different operations. According to this configuration, two operations can be performed by means of a single button. Thus, the number of control buttons 51 can be reduced to achieve cost reduction, and the cabinet 12 can be miniaturized.

Distance D1 between the depression 56 and the plane 32A that passes through the bottom of the second recess 32 is substantially equal to distance D2 between the plane 32A and second edge portion 42. According to this configuration, a fingertip can be easily guided into the depression 56, so that the control button 51 can be operated with the fingertip in the depression 56. Thus, operability can be improved.

The portable computer 61 comprises the sixth face 26, which is disposed on the cabinet 12, faces the fifth face 25 such that it is continuous with the first to fourth faces 21 to 24, and comprises the inwardly recessed third recess 33, and the label 53, which is disposed in the third recess 33 and carries data. According to this configuration, the label 53 is set in such a position that it cannot be easily peeled off the cabinet 12. Thus, the label 53 can be prevented from unexpectedly separating from the cabinet 12.

The portable computer 61 comprises the speaker 54 disposed in the cabinet 12 and the openings 55 arranged near the speaker 54 in the third recess 33. According to this configuration, the openings 55 through which sound from the speaker 54 is emitted can be prevented from being closed even if the portable computer 61 is placed such that the sixth face 26 contacts a wall or the like.

The cabinet 12 comprises: the first case 34 which comprises the first face 21 and to which the display panel 17 is secured; the second case 35 which comprises the second face 22 and is attachable/detachable to or from the first case 34 in the direction along the second face 22; and the fixing members 36 that extend in the direction along the second face 22 and secure the first and second cases 34 and 35 to each other. According to this configuration, the thickness of the cabinet 12 can be reduced by arranging the fixing members 36 along the second face 22.

The cabinet 12 comprises the hollow 46 that is further recessed from the first to third recesses 31 to 33 such that it spans between the recesses 31 to 33. According to this configuration, the appearance of the cabinet 12 can be improved and the thinness of the cabinet can be accentuated.

The first to third edge portions 41 to 43 are slanted so that the corners between the first face 21 and the fourth to sixth faces 24 to 26 and the corners between the second face 22 and the fourth to sixth faces 24 to 26 are removed. According to this configuration, the cabinet 12 can be improved in appearance by being rounded and made to look thinner.

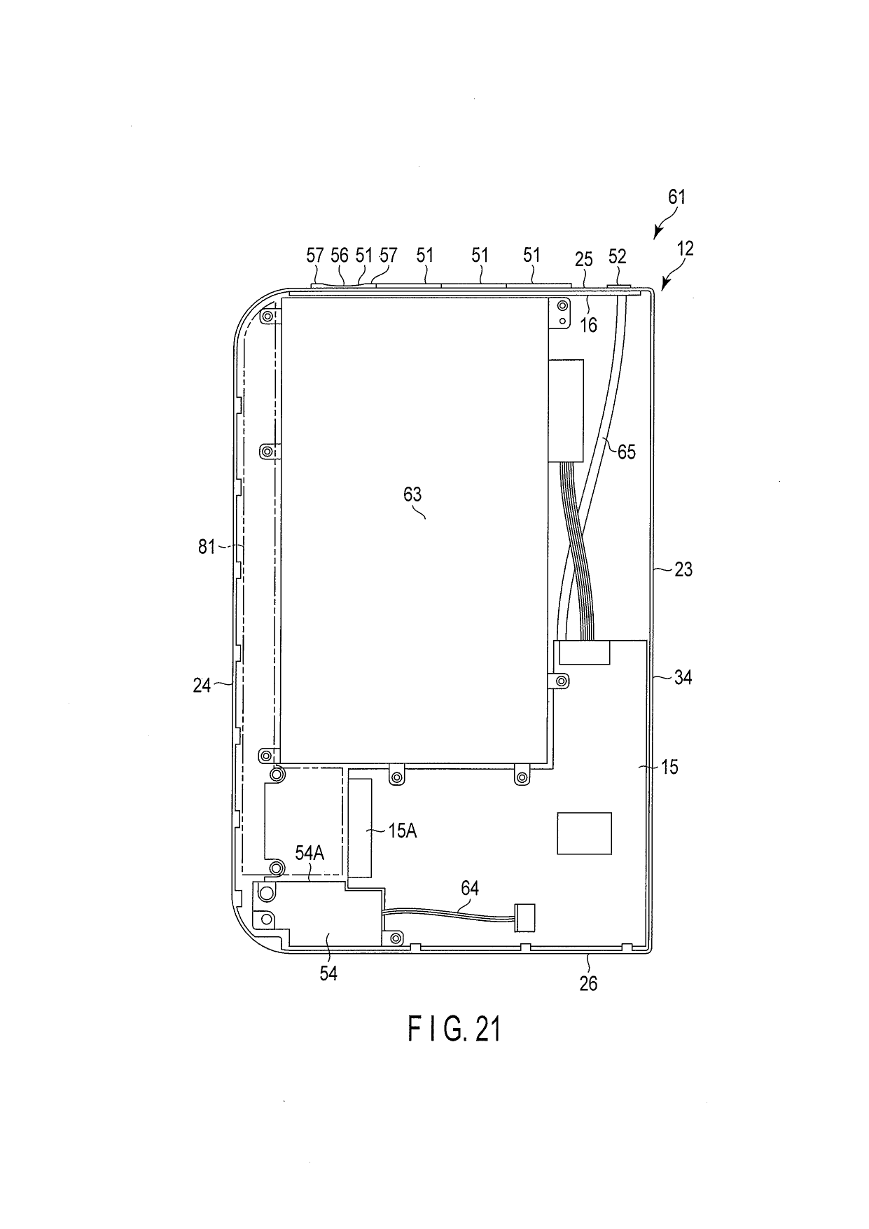

Referring now to FIG. 21, a modification of the portable computer as an example of the electronic apparatus of the third embodiment will be described. As shown in FIG. 21, the portable computer 61 comprises, in its cabinet 12, a region 81 where sound from the speaker 54 resonates. The periphery of the region 81 is defined by a part (fourth face 24) of the cabinet 12, speaker 54, printed circuit board 15 (or a connector 15A on the printed circuit board 15), and battery 63. Further, a plurality of openings 54A in the speaker 54 are directed to the region 81.

According to this modification, the region 81 can be disposed within the cabinet 12, so that the sound effect can be improved to give the portable computer 61 a high-quality feel.

The electronic apparatus is not limited to the television 11 and portable computer 61 according to the embodiments described above, and is naturally applicable to some other electronic apparatus, such as a cell phone.

The electronic apparatus is not limited directly to the above-described embodiments. In practice, the structural elements may be modified and embodied without departing from the spirit of the invention. Further, various inventions can be made by properly combining a plurality of structural elements disclosed in the above-described embodiments. For example, some structural elements may be deleted from all the structural elements disclosed in the embodiments. Furthermore, structural elements of different embodiments may be combined as required.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A television comprising:
a display panel comprising one surface on which an image is displayed and the other surface opposite the one surface;
a printed circuit board electrically connected to the display panel; and
a cabinet which comprises a first face along the one surface, a second face along the other surface, a third face ranging between the first and second faces and projecting outside the first and second faces, and a fourth face ranging between the first and second faces in a position different from that of the third face and comprising a first recess recessed inside the first and second faces and accommodates the display panel and the printed circuit board,
the printed circuit board being located nearer to the third face than to the fourth face in the cabinet,
the first recess comprising an opening through which a receiving portion electrically connected to the printed circuit board and configured to receive an external operation input is exposed,
a distal end of the receiving portion projecting outside the first and second faces.

2. The television of claim 1, further comprising a fifth face disposed on the cabinet so as to be continuous with the first to fourth faces and comprising a second recess recessed inward, wherein the receiving portion comprises a plurality of control buttons arranged side by side in the second recess and a power button located in line with the control buttons in the second recess.

3. The television of claim 2, wherein the power button is located deeper in the cabinet than the control buttons.

4. The television of claim 2, wherein the power button is movable across the fifth face, and when in a normal position, is located deeper in the cabinet than a second edge portion which defines the periphery of the second recess.

5. The television of claim 1, wherein the third face has an arcuate cross-section.

6. The television of claim 2, wherein the power button is disposed near the third face and has an oblong shape similar to that of the third face 23.

7. The television of claim 2, further comprising a fifth face disposed on the cabinet so as to be continuous with the first to fourth faces and comprising a second recess recessed inward, wherein the control buttons, when in a depressed position, are located deeper in the cabinet than a second edge portion which defines the periphery of the second recess.

8. The television of claim 1, further comprising a sixth face, disposed on the cabinet so as to be continuous with the first to fourth faces and comprising a third recess recessed inward, and a label which is disposed in the third recess and carries data.

9. The television of claim 1, further comprising a sixth face disposed on the cabinet so as to be continuous with the first to fourth faces and comprising a third recess recessed inward, a speaker disposed in the cabinet, and a plurality of openings disposed near the speaker in the third recess.

10. The television of claim 1, further comprising a fifth face, disposed on the cabinet so as to be continuous with the first to fourth faces and comprising a second recess recessed inward, and a sixth face, disposed on the cabinet so as to be continuous with the first to fourth faces and comprising a third recess recessed inward, wherein the cabinet comprises a hollow further recessed from the first to third recesses such that the hollow spans between the first to third recesses.

11. The television of claim 1, further comprising a fifth face, disposed on the cabinet so as to be continuous with the first to fourth faces and comprising a second recess recessed inward, and a sixth face, disposed on the cabinet so as to be continuous with the first to fourth faces and comprising a third recess recessed inward, wherein the cabinet comprises a first edge portion which defines the periphery of the first recess, a second edge portion which defines the periphery of the second recess, and a third edge portion which defines the periphery of the third recess, the first to third edge portions being slanted so that corners between the first face and the fourth to sixth faces and corners between the second face and the fourth to sixth faces are removed.

12. An electronic apparatus comprising:
a display panel comprising one surface and the other surface opposite the one surface; and
a cabinet which comprises a first face along the one surface, a second face along the other surface, a third face longitudinally extending so as to be continuous with the first and second faces and projecting outward, and a fourth face facing the third face so as to be continuous with the first and second faces and comprising a first recess recessed inward and accommodates the display panel.

13. The television of claim 3, wherein the power button is movable across the fifth face, and when in a normal position, is located deeper in the cabinet than a second edge portion which defines the periphery of the second recess.

14. The television of claim 9, further comprising a fifth face, disposed on the cabinet so as to be continuous with the first to fourth faces and comprising a second recess recessed inward, and a sixth face, disposed on the cabinet so as to be continuous with the first to fourth faces and comprising a third recess recessed inward, wherein the cabinet comprises a hollow further recessed from the first to third recesses such that the hollow spans between the first to third recesses.
